(19) United States
(12) Patent Application Publication
(10) Pub. No.: US 2020/0074325 A1
(43) Pub. Date: Mar. 5, 2020

(54) Systems and Methods for Creating an Optimal Prediction Model and Obtaining Optimal Prediction Results Based on Machine Learning

(71) Applicant: National Chiao Tung University, Hsinchu (TW)

(72) Inventors: Wei-Cheng Lo, Hsinchu (TW); Yu-Hung Chen, Hsinchu (TW); Shun-Yu Jhong, Hsinchu (TW)

(21) Appl. No.: 16/555,292

(22) Filed: Aug. 29, 2019

(30) Foreign Application Priority Data
Aug. 29, 2018 (TW) 107130186

(51) Int. Cl. G06N 5/04; G06N 20/00

(52) U.S. Cl. CPC G06N 5/04; G06N 20/00

(57) ABSTRACT

The present invention provides Systems and Methods for Creating an Optimal Prediction Model and Obtaining Optimal Prediction Results Based on Machine Learning. In the method for creating an optimal prediction model, the steps are first to input a plural training data and at least one of machine learning algorithms, then convert the training data into a relay format. The method is further to select the automated predictive features, optimize the machine learning algorithm parameter, and then optimize the iterative prediction model. After that, a prediction model and an accuracy assessment data are outputted. In the process of obtaining the prediction result, the data to be predicted is converted into a relay format, and an automated program is used for iterative prediction to generate and output the prediction result and accuracy evaluation data.

### CROSS-REFERENCE TO RELATED APPLICATIONS

This non-provisional application claims priority under 35 U.S.C. § 119 on Patent Application No. TW107130186 filed in Taiwan, Republic of China Aug. 29, 2018, the entire contents of which are hereby incorporated by reference in its entirety.

### FIELD OF THE INVENTION

The present invention relates generally to systems and methods for creating a prediction model and obtaining the prediction results, and more particularly to systems and methods for creating an optimal prediction model and obtaining the optimal prediction results based on machine learning.

### BACKGROUND OF INVENTION

In recent years, with the great progress of artificial intelligence technology, the application field of the artificial intelligence has been extended, and the artificial intelligence will bring more convenience to the human life.

Machine learning is a part of artificial intelligence. The machine learning aims to make the computer have the ability to learn. In order to make the computer gain the ability of pattern recognition and object classification, the computer must be trained using existing data of known recognitions or classifications, and then make predictions for data of unknown recognitions or classifications. The entire program contains the obtained data, analyzed data, built model, future prediction and other steps.

Conventionally, a computer system with artificial intelligence requires a high professional ability. For example, due to the operation of related software, the integration of data obtained and algorithm is not easy, and relevant personnel must have a good understanding on the theory of machine learning. Good programming skills are required to complete the training and prediction procedure of the aforementioned machine learning. In addition, due to lack of automation and modular design of the current model training, the selection of predictive features, the determination of algorithm parameters, the integration of algorithms, and the accuracy optimization must rely on the experience of the relevant personnel, resulting in the instability of the quality of the output model and the bias in learning and prediction.

In view of this, if the obtaining of data, the selection of predictive features, the determination of algorithm parameters, the integration of algorithms, and the accuracy optimization can be realized in the mechanism of machine learning by automation and modular design, the efficiency of machine learning and training, the convenience of use and the accuracy of prediction will be greatly improved.

### SUMMARY OF THE INVENTION

A method for creating an optimal prediction model based on machine learning comprises following steps (a) to (i): (a) A training data set with a data format is provided by a user, and a plural machine learning algorithm to be used, a maximum number of repetitions and a target prediction accuracy are selected; (b) A conversion program is used for obtaining a formatted original data by converting the data format of the training data to a relay format, and the machine learning algorithm is set with the first predictive features and a parameter setting group; (c) The formatted original data is divided into a sub-training set and a sub-testing set; (d) The first sub-predictive model is created by using the machine learning algorithm and the data values contained in the sub-training set; (e) The data values contained in the sub-testing set are subject to the first sub-prediction model, and the first accuracy is obtained by the plural prediction algorithm; (f) If the data values of the formatted original data are used as both the sub-training set and the sub-test set, or the number of repetitions meets the maximum number of repetitions, then the nth predictive features and the parameter setting group are modified according to the nth accuracy to obtain the n+1^{th} predictive features and a parameter setting group, conversely, repeat Step c)˜e); (g) The machine learning algorithm is set by the nth predictive features and the parameter setting group. The first prediction model is created by using the machine learning algorithm and the data values contained in the formatted original data; (h) If the n^{th} accuracy meets the target prediction accuracy or the number of repetitions meets the maximum number of repetitions, the n^{th} prediction model is provided as an optimal prediction model. Conversely, the n^{th} predictive features and the parameter setting group are modified according to the accuracy to obtain the n+1^{th} predictive features and parameter setting group for setting the machine learning algorithm, then, repeat Step c)˜e); and (i) The optimal prediction model and the nth accuracy are shown.

The method defined in claim 1, wherein, Step h further includes the following steps, (h1) to (h2): (h1) The n+1^{th} predictive features and the parameter setting group are stored into a temporary data storage area; and (h2) If the number of repetitions meets the maximum number of repetitions, the machine learning algorithm will be set by the greatest accuracy selected from the temporary data storage area.

The method defined in claim 1, wherein, Step c further includes the following steps : (c1) After the data values of the formatted original data are divided into a training set and a testing set, the training set is then divided into the sub-training set and the sub-testing set; And, Step g further includes the following steps (g1) to (g3):(g1) The first prediction model is created by the machine learning algorithm and the data values contained in the training set; (g2) The data values contained in the testing set are subject to the first prediction model, and the first testing accuracy is obtained by using the prediction algorithm; and(g3) The first testing accuracy is replaced with the first accuracy.

The method defined in claim 1, wherein, Step a further includes the following steps: (a1) Select one balance base number (n) for the use of sample classification; And, Step d further includes the following steps (d1) to (d4): (d1) The data values contained in the sub-training set are divided into plural sampling categories by the machine learning algorithm which has different sampling categories: (d2) Sampling from each sampling category with the balance base number to construct a sample combination; (d3) The first sample prediction model is created by using the data values contained in the sample combination; and (d4) Repeat Step (d2)˜(d3) until the maximum number of repetitions (t) is met to obtain a plural sample prediction model, then combine the sample prediction models to form the first sub-prediction model.

The method defined in claim 1, wherein, Step e further includes the following steps:(eap1) the first plural sample accuracy is respectively obtained by the prediction algorithm; and(eap2) The highest confidence index of the first sample accuracy which selected by a voting mode or an average mode becomes the first prediction result.

The method defined in claim 1, wherein, Step e further includes the following steps:(e1) The first accuracy index is obtained by comparing the first accuracy and a known result; And, Step f further includes the following steps:(f1) The n^{th} predictive features and the parameter setting group are modified according to the nth accuracy and the n^{th} accuracy index.

The method defined in claim 6, wherein, the accuracy index includes the accuracy, AUC and MCC.

The method defined in claim 1, in Step b, the conversion program plurally repeats to compare the data format then, the conversion program is selected.

The method defined in claim 1, wherein, the data format is csv file or text file.

A method based on machine learning for obtaining an optimal prediction result comprises the following steps (a) to (c): (a) A user provides the dataset to be predicted with a data format and selects an optimal prediction model and a plural prediction model to be used; (b) A conversion program is used to obtain a formatted original data by converting the data format of which to be predicted into a relay format; and (c) The data values contained in the formatted original data are subject to the optimal prediction model, and an optimal prediction result and an optimal accuracy index are obtained through the prediction algorithm.

The method defined in claim 10, wherein, Step a further includes the following steps :(a1) Further select an maximum number of repetitions; And, Step c further includes: (c1) to (c2): (c1) The formatted original data is the first formatted original data, and the data values contained in the first formatted original data are subject to the optimal prediction model, then obtain the first prediction result from the prediction algorithm; (c2) The n^{th} formatted data to be predicted is combined with the n^{th} prediction result for obtaining the n+1^{th} formatted data to be predicted, and then repeat Step c1) until the number of repetitions meets the maximum number of repetitions, which provides the n+1^{th} prediction result as an optimal prediction result.

The method defined in claim 11, wherein, Step c1 further includes the following steps: (c1p1) The first accuracy is obtained by using the prediction algorithm, and the first accuracy index is obtained by comparing the first accuracy and a known result; And, Step c2 further includes the following steps:(c2p1) The n+1^{th} accuracy index is provided as the optimal accuracy index.

The method defined in claim 12, wherein, the accuracy index includes the accuracy, AUC and MCC.

A system for creating an optimal prediction model based on machine learning comprises: a storage unit is configured to store the training data set with a data format, and a plural machine learning algorithm; and a processing unit is coupled to the storage unit for configuration to perform the following methods and steps (a) to (i): (a) Receive a maximum number of repetitions and a target prediction accuracy; (b) A conversion program is used for obtaining a formatted original data by converting the data format of the training data to a relay format, and the machine learning algorithm is set by the first predictive features and a parameter setting group; (c) The data values of the formatted original data are divided into a sub-training set and a sub-testing set; (d) The first sub-predictive model is created by using the machine learning algorithm and the data values contained in the sub-training set; (e) The data values contained in the sub-testing set are subject to the first sub-prediction model, and the first accuracy is obtained by the plural prediction algorithm; (f) If the data values of the formatted original data were used as both the sub-training set and the sub-testing set, or the number of repetitions meets the maximum number of repetitions, the n^{th} predictive features and the parameter setting group are modified according to the n^{th} accuracy to obtain the n+1^{th} predictive features and a parameter setting group, conversely, repeat Step c)˜e); (g) The machine learning algorithm is set by the n^{th} predictive features and the parameter setting group. The first prediction model is created by using the machine learning algorithm and the data values contained in the formatted original data; (h) If the n^{th} accuracy meets the target prediction accuracy or the number of repetitions meets the maximum number of repetitions, the n^{th} prediction model is provided as an optimal prediction model. Conversely, the n^{th} predictive features and the parameter setting group are modified according to the accuracy to obtain the n+1^{th} predictive features and a parameter setting group for setting the machine learning algorithm, then, repeat Step c)˜e); and (i) The optimal prediction model and the n^{th} accuracy are shown.

A method for obtaining an optimal prediction result based on machine learning comprises: a storage unit is configured to store the dataset to be predicted with a data format, an optimal prediction model and a plural prediction algorithm; and a processing unit is coupled to the storage unit for configuration to perform the following methods and steps (a) to (c): (a) Select the optimal prediction model and the prediction algorithm; (b) A conversion program is used for obtaining a formatted original data by converting the data format of the training data to a relay format; and(c) The data values contained in the formatted original data are subject to the optimal prediction model, and an optimal prediction result and an optimal accuracy index are obtained through the prediction algorithm.

### BRIEF DESCRIPTION OF THE DRAWINGS

FIG. 1 shows a system 1000 for creating an optimal prediction model based on machine learning according to an embodiment of the present invention.

FIG. 2 shows a method for creating an optimal prediction model based on machine learning according to an embodiment of the present invention.

FIG. 3 shows a method for creating an optimal prediction model based on machine learning according to another embodiment of the present invention.

FIG. 4 shows an automatic predictive features selection and a parameter optimization method (algorithm M) of machine learning algorithm according to an embodiment of the present invention.

FIGS. 5A and 5B show a method for modularly creating a prediction model (algorithm T) according to an embodiment of the present invention.

FIG. 6A and 6B show an equalized data sampling mode and a random forest prediction model training method (algorithm AT) according to an embodiment of the present invention.

FIGS. 7A and 7B show a prediction accuracy optimization method (algorithm O) according to an embodiment of the present invention.

FIG. 8 shows a system for obtaining the optimal prediction results based on machine learning according to an embodiment of the present invention.

FIG. 9 shows a method for obtaining the optimal prediction results based on machine learning according to an embodiment of the present invention.

FIG. 10 shows a method for obtaining the optimal prediction results based on machine learning according to another embodiment of the present invention.

FIG. 11 shows an iterative prediction method (algorithm IP) according to an embodiment of the present invention.

FIG. 12 shows a modularized data prediction method (algorithm P) according to an embodiment of the present invention.

FIG. 13 shows a random forest data prediction method (algorithm AP) according to an embodiment of the present invention.

### DETAILED DESCRIPTION OF THE INVENTION

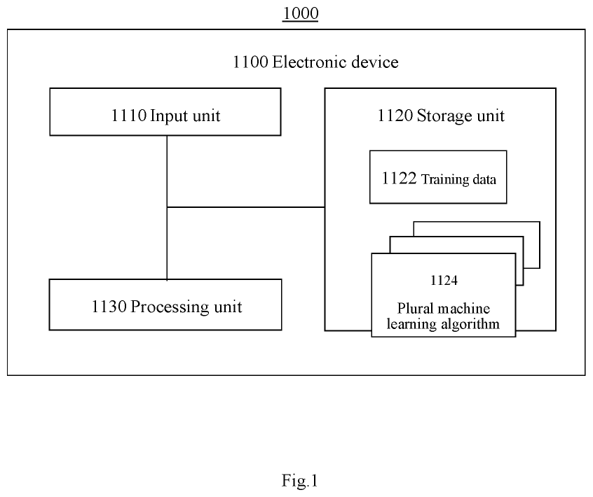

FIG. 1 shows a system 1000 for creating an optimal prediction model based on machine learning according to an embodiment of the present invention. The system 1000 for creating an optimal prediction model based on machine learning can be applied to an electronic device 1100, such as, a single-core or multi-core computing device, and it can be in a stand-alone environment or a clustered environment. The electronic device 1100 includes a data input unit 1110, a storage unit 1120, and a processing unit 1130. The data input unit 1110 can be used to receive the plural training data. The storage unit 1120 can store the training data 1122 received by the data input unit 1110 and the plural machine learning algorithm 1124. It is noted that, in some embodiments, the data format is csv file or text file. Moreover, the system can receive an advanced system configuration for setting the system through the data input unit 1110, such as the size of the random forest, or the voting mechanism of the prediction results and the detailed parameters of each algorithm. The processing unit 1130 can control the operations of related software and hardware in the electronic device 1100 and carry out the method for creating an optimal prediction model based on machine learning in the present case, the details of which will be described later.

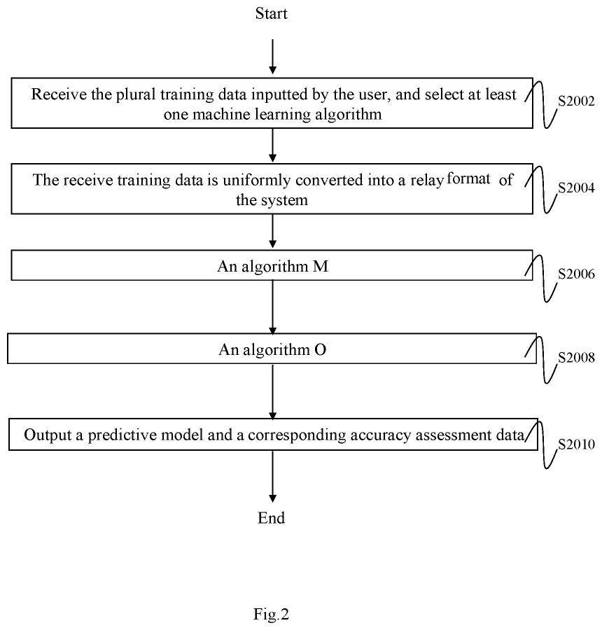

FIG. 2 shows a method for creating an optimal prediction model based on machine learning according to an embodiment of the present invention. The method for creating an optimal prediction model based on machine learning according to an embodiment of the present invention is applicable to the electronic device shown in FIG. 1.

First, in Step S2002, receive the plural training data inputted by the user, and select at least one machine learning algorithm. It is noted that, in some embodiments, an advanced system configuration may be further received for setting the system. Next, in Step S2004, the received training data is uniformly converted into one relay format of the system. Noting that the received training data may have different data formats. In Step S2004, the training data set with different formats will be converted into the relay format for subsequent processing. Thereafter, in step S2006, an algorithm M is implemented for performing automatic predictive features selection and machine learning algorithm parameter optimization. In step S2008, an algorithm O is performed for performing iterative prediction model optimization. Finally, in Step S2010, a prediction model and corresponding accuracy evaluation data are outputted. Algorithm M and algorithm O will be described in detail later.

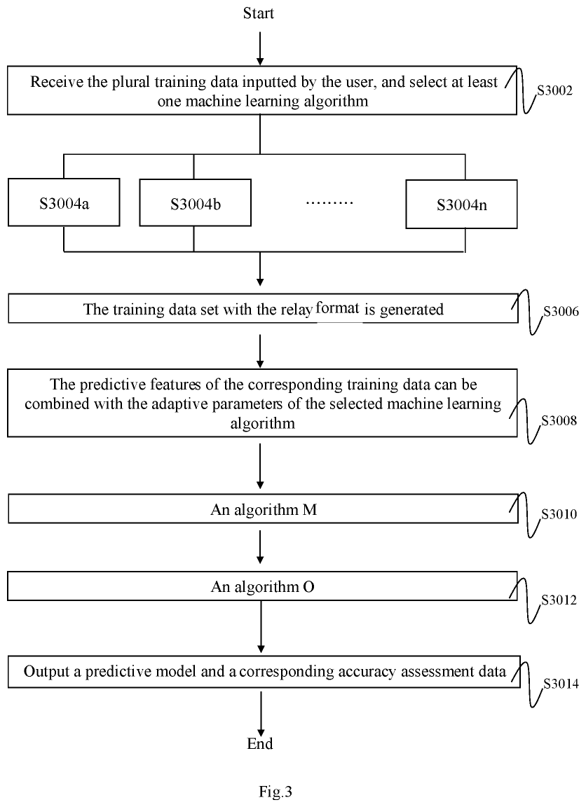

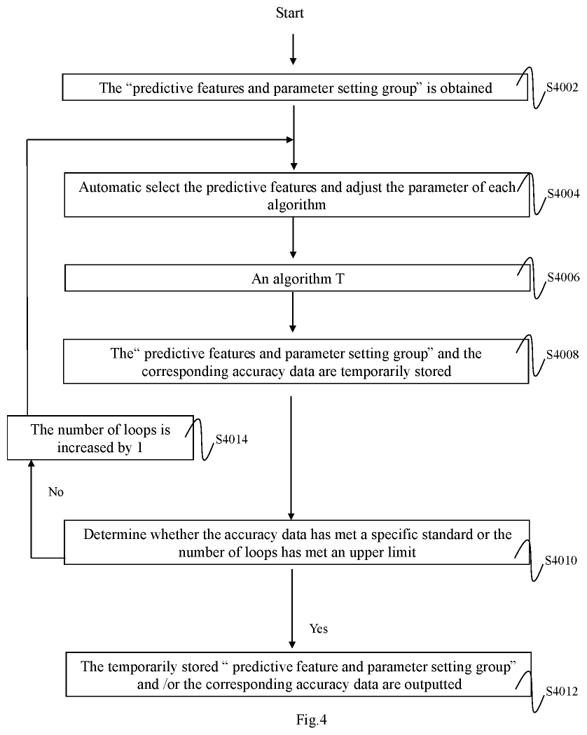

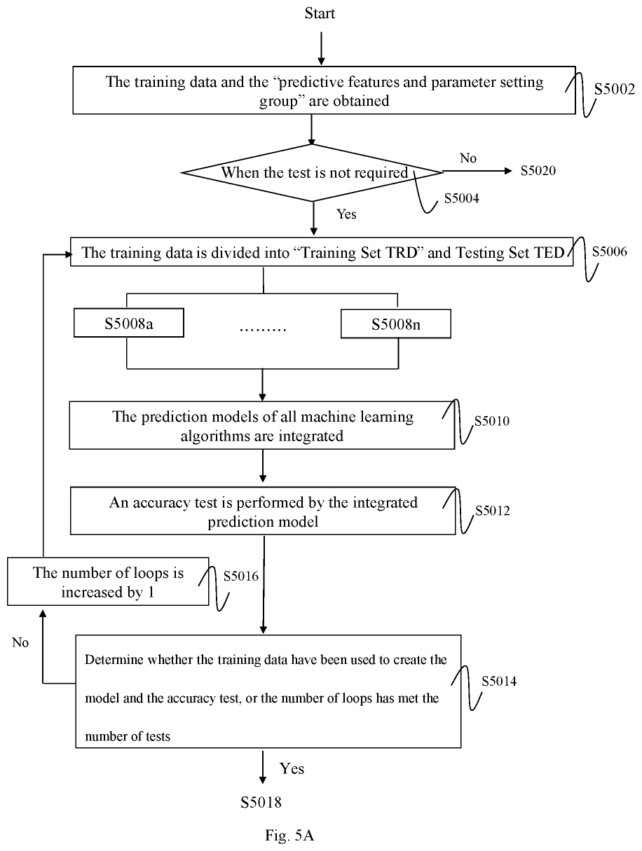

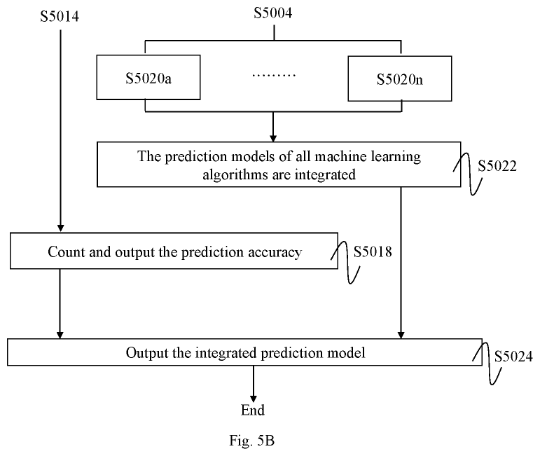

FIG. 3 shows a method for creating an optimal prediction model based on machine learning according to another embodiment of the present invention. The method for creating an optimal prediction model based on machine learning according to an embodiment of the present invention is applicable to the electronic device shown in FIG. 1.

First, in Step S3002, receive the plural training data inputted by the user, and select at least one machine learning algorithm. Similarly, in some embodiments, an advanced system configuration may be further received for setting the system. Then, in Step S3004a, S3004b, . . . , S3004n, the training data set with different formats is uniformly converted into one relay format of the system by corresponding conversion programs of different formats. And, in Step S3006, the training data with the relay format is generated, which called “formatting the original data”. Then, in Step S3008, combines the predictive features of the corresponding training data with the adaptive parameters of the selected machine learning algorithm to control the detailed operation of each calculus, such as the layer number of the artificial neural network and the node number of each layer, so as to become the “predictive features and parameter setting group”. Thereafter, in Step S3010, an algorithm M is implemented for performing automatic predictive features selection and machine learning algorithm parameter optimization. In Step S3012, an algorithm O is performed for performing iterative prediction model optimization. Finally, in Step S3014, output a prediction model and a corresponding accuracy evaluation data. Similarly, algorithm M and algorithm O will be described in detail later.

FIG. 4 shows an automatic predictive features selection and machine learning algorithm parameter optimization method (algorithm M) according to an embodiment of the present invention. In this embodiment, “predictive features selection” and “algorithm parameter optimization” can be performed according to an automation program.

In Step S4002, the “predictive features and parameter setting group” is obtained. In Step S4004, the predictive features is programmatically selected and the parameters of each algorithm are adjusted. In other words, the “predictive features and parameter setting group” is programmatically adjusted. In Step S4006, an algorithm T is performed for creating a prediction model according to the “predictive features and parameter setting group” and testing the accuracy. It is noted that, in some embodiments, Step S4004 can be a simple random selection and adjustment. In some embodiments, Step S4004 can be performed by using Monte Carlo algorithm, genetic algorithm and/or its derivative algorithms. The algorithm T will be described later. After that, in Step S4008, the “predictive features and parameter setting group” and the corresponding accuracy data are temporarily stored. In Step S4010, it determines whether the accuracy data has met a specific standard or the number of the loops has met an upper limit. Noting that, the specific standard or number of loops can be set by the system default or by a user. When the accuracy data does not meet the specific standard or the number of loops does not meet the upper limit (“No” in Step S4010), in Step S4014, the number of loops is increased by 1, and the flow returns to Step S4004. When the accuracy data meets a specific standard or the number of loops meets the upper limit (“Yes” in Step S4010), in Step S4012, the temporarily stored “predictive features and parameter setting group” and/or the corresponding accuracy data will be outputted.

FIGS. 5A and 5B show a method for modularly creating a prediction model (algorithm T) according to an embodiment of the present invention. In this embodiment, a prediction model can be created through a modularized program.

In Step S5002, the training data and the “predictive features and parameter setting group” are obtained. In Step S5004, it determines whether the test is required. When the test is required (“Yes” in Step S5004), in Step S5006, the training data is divided into “Training Set TRD” and “Testing Set TED”. It is noted that, Step S5006 can be implemented in different ways. In some embodiments, the division method can be based on the way of N-fold cross validations, random grouping, or combining N-fold Cross validations with random grouping. It is noted that, the foregoing division method is only an example of the present case, and the present invention is not limited thereto. In Step S5008a, S5008b, S5008n, the training set TRD is put into a modularized program for selecting the machine learning algorithm to create the predictive model of each method. It is noted that, the algorithm AT is used to implement the above modularized program, the details of which will be described later. After that, as in Step S5010, the prediction models of all machine learning algorithms are integrated, then, in Step S5012, according to the testing set TED, an accuracy test is performed by the integrated prediction model. It is noted that, the algorithm P is used to implement the above accuracy test, the details of which will be described later. Next, in Step S5014, it determines whether all the training data have been used to create the model and the accuracy test or the number of loops has met a test number. It is noted that, the number of tests can be set by the system default or by a user. When not all the training data have been used to create the model and the accuracy test or the number of loops does not meet the number of tests (“No” in Step S5014), as in Step S5016, the number of loops is increased by 1, and the flow returns to Step S5006. When all the training data have been used to create the model and the accuracy test or the number of loops has met the number of tests (“Yes” in Step S5014), as in Step S5018, statistic and output the prediction accuracy, then output the integrated prediction model as in Step S5024. When the test is not required (“No” in Step S5004), as in Step S5020a, S5020b, . . . , S5020n, all the formatted original data FOD are put into a modularized program for selecting the machine learning algorithm to create the predictive model of each method. Similarly, the algorithm AT is used to implement the above modularized program, the details of which will be described later. After that, as in Step S5022, the prediction models of all machine learning algorithms are integrated, and as in Step S5024, output the integrated prediction model.

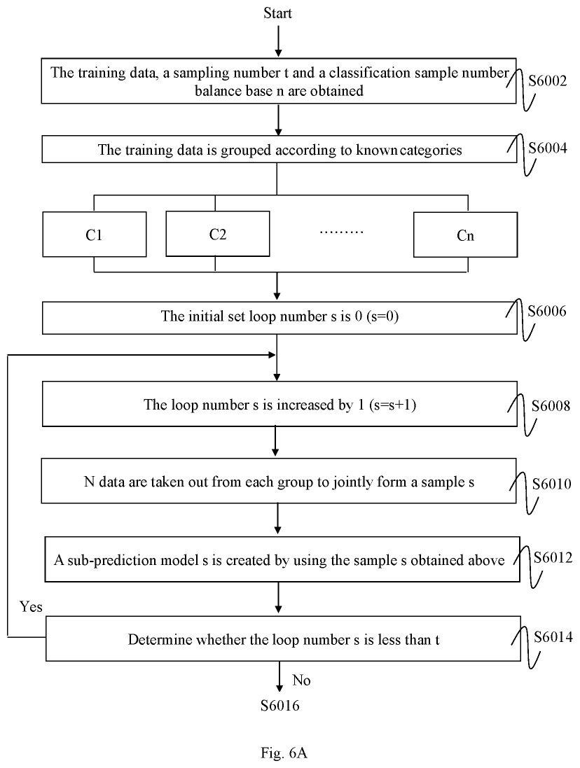

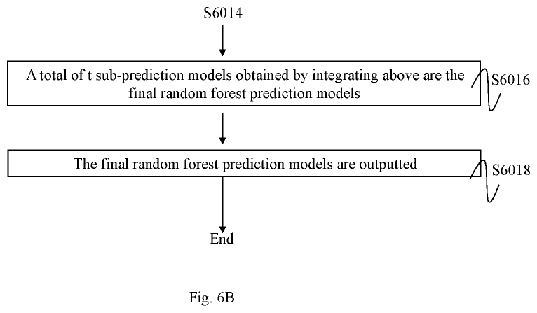

FIGS. 6A and 6B show an equalized data sampling mode and a random forest prediction model training method (algorithm AT) according to an embodiment of the present invention. In this embodiment, the “bias” and “over-adaptation” of the prediction system can be effectively reduced.

In Step S6002, the training data, a sampling number t and a classification sample number balance base n are obtained. It is noted that, in this procedure, samples are sampled t times and t sub-prediction models are created. In Step S6004, the training data is classified according to known categories, so as to generate Category 1, Category 2, . . . , Category n (C1, C2, . . . , Cn). For example, there are 4 known correct results: heart disease, diabetes, gout, and no such diseases, then the training data can be divided into 4 groups according to the correct results. In Step S6006, the initial set loop number s is 0 (s=0), and in Step S6008. the loop number s is increased by 1 (s=s+1). In Step S6010, in a random and repeatable manner, n data are taken out from each group to jointly form a sample s, and in Step S6012, a sub-prediction model s is created by using the sample s obtained above. In Step S6014, it determines whether the loops number s is less than t. When the loops number s is less than t (“Yes” in Step S6014), the flow returns to Step S6008. When the loops number s is not less than t (“No” in Step S6014), as in Step S6016, a total of t sub-prediction models obtained by integrating above are the final random forest prediction model, and the final random forest prediction model will be outputted as in Step S6018.

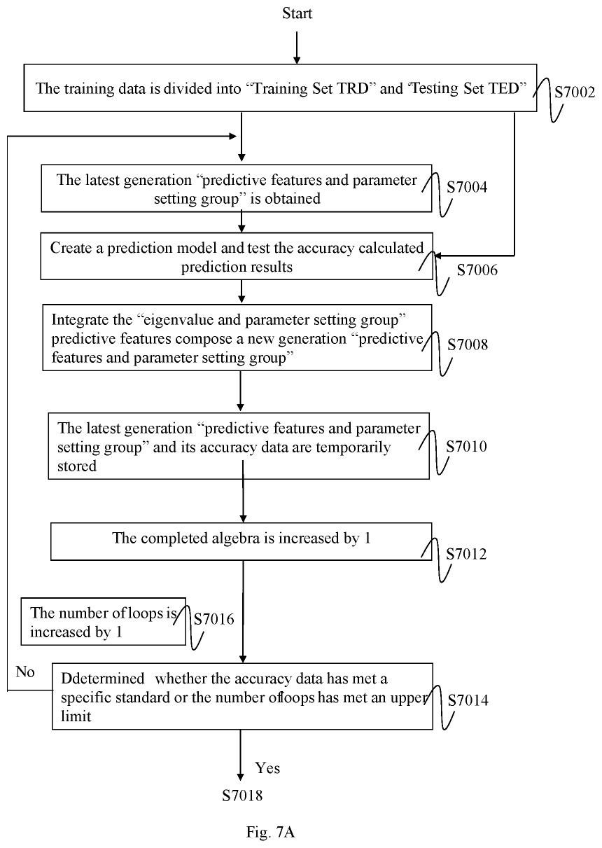

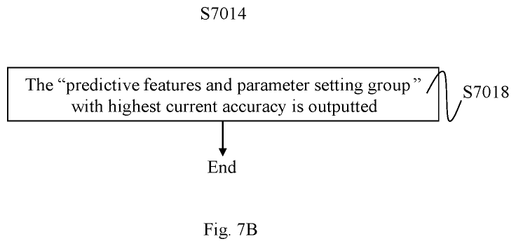

FIGS. 7A and 7B show a prediction accuracy optimization method (algorithm O) according to an embodiment of the present invention. In this embodiment, “iterative prediction model optimization” can be performed by an automated program.

In Step S7002, the training data is obtained and the training data is divided into “Training Set TRD” and “Testing Set TED”. In Step S7004, the latest generation “predictive features and parameter setting group” is obtained. In Step S7006, create a prediction model and compute the prediction results according to the “Testing Set TED” and the algorithm T of the embodiment of FIG. 5, such as probability values and/or confidence index, and testing the accuracy. Then, as in Step S7008, integrate the “predictive features and parameter setting group” and the prediction result of Step S7006 to compose a new generation “predictive features and parameter setting group”. In other words, the predicted data can be added into the “predictive features and parameter setting group” as a new predictive features. In Step S7010, the latest generation “predictive features and parameter setting group” and its accuracy data are temporarily stored. Thereafter, in Step S7012, the completed algebra is increased by 1, and in Step S7014, it determines whether the accuracy data has met a specific standard or the number of loops has met an upper limit. It is noted that, the specific standard or algebra upper limit can be set by system default or by a user. When the accuracy data does not meet the specific standard or the number of loops does not meet the algebra limit (“No” in Step S7014), as in Step S7016, the number of loops is increased by 1 and the flow returns to Step S7004. When the accuracy data meets a specific standard or when the number of loops meets the upper limit of algebra (“Yes” in Step S7014), in Step S7018, the “predictive features and parameter setting group” with highest current accuracy will be outputted.

It should be noted that, in some embodiments, the algorithm M and the algorithm O can be implemented as two steps of the upstream and the downstream, as shown in the embodiment of FIG. 3. In some embodiments, the algorithm M and the algorithm O can also be integrated as a step by covering each other. For example, replacing the algorithm T step used in the algorithm O with the algorithm M, or replacing the algorithm T step used in the algorithm M with the algorithm O.

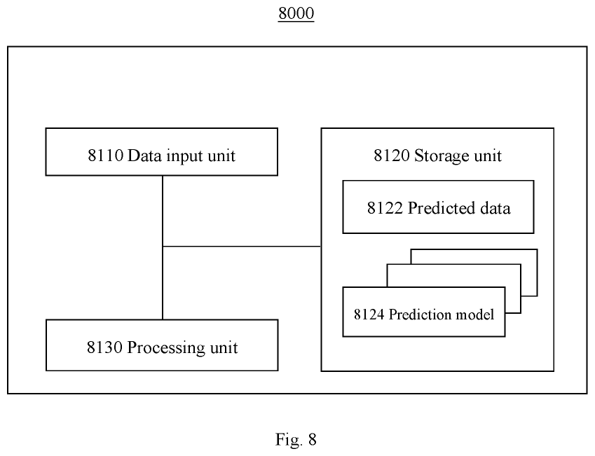

FIG. 8 shows an obtaining system for optimizing prediction results based on machine learning according to an embodiment of the present invention. The obtaining system 8000 based on machine learning using for optimizing prediction results according to an embodiment of the present invention can be applied to an electronic device 8100, such as, a single core or multi-core computing device, and it can be a in stand-alone environment or a clustered environment. The electronic device 8100 includes a data input unit 8110, a storage unit 8120, and a processing unit 8130. The data input unit 8110 can be used to receive the data to be predicted. The storage unit 8120 can store the data to be predicted 8122 received by the data input unit 8110, and a prediction model 8124. It is noted that, in some embodiments, the system can receive an advanced system configuration for setting the system through the data input unit 8110. The processing unit 8130 can control the operations of the related software and hardware in the electronic device 8100 and perform the prediction result optimization based on the machine learning in the present case. The method and the details will be described later.

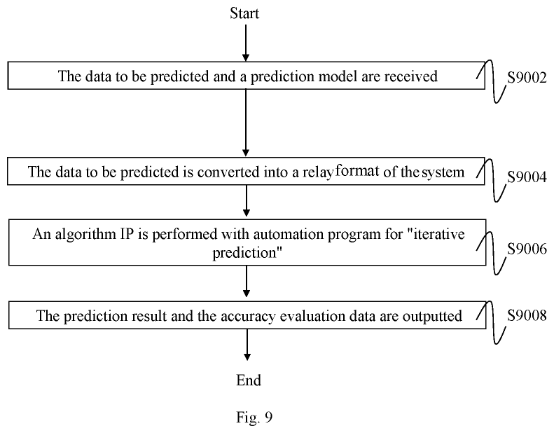

FIG. 9 shows a method for obtaining optimal prediction results based on machine learning according to an embodiment of the present invention. The method for obtaining the optimal prediction results based on machine learning according to an embodiment of the present invention is applicable to the electronic device shown in FIG. 8.

First, in Step S9002, the data to be predicted and a prediction model are received. It is noted that, in some embodiments, the prediction model may be generated according to the embodiment of FIG. 2 or FIG. 3. It is noted that, in some embodiments, an advanced system configuration can be further received for system setting. In step S9004, the data to be predicted is converted into a relay format of the system. It is noted that, the received data to be predicted may set with different data formats. In Step S9004, the data to be predicted set with different formats are respectively converted into the relay format for subsequent processing. Thereafter, in Step S9006, an algorithm IP is performed with automation program for “iterative prediction”, and as in Step S9008, the prediction result and the accuracy evaluation data are outputted. The algorithm IP will be described later.

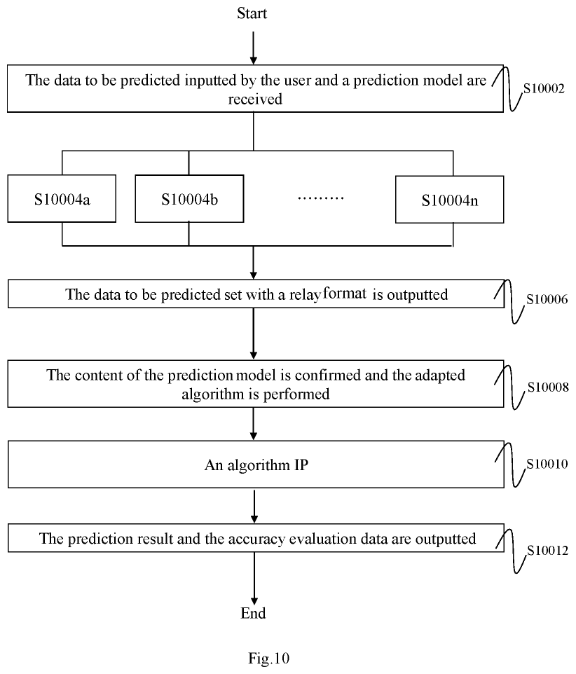

FIG. 10 shows a method for obtaining an optimal prediction result based on machine learning according to another embodiment of the present invention. The method for obtaining an optimal prediction result based on machine learning according to the embodiment of the present invention is applicable to the electronic device shown in FIG. 8.

First, in Step S10002, the data to be predicted inputted by the user and a prediction model are received. It is noted that, in some embodiments, the prediction model may be generated according to the embodiment of FIG. 2 or FIG. 3. It is noted that, in some embodiments, an advanced system configuration may be further received for system setting. Then, in Step S10004a, S10004b, . . . , S10004n, the dataset to be predicted with different formats are uniformly converted into a relay format of the system by a different formats conversion program, then, in Step S10006, the dataset to be predicted with relay format is outputted and called as “formatted data to be predicted”. Next, in Step S10008, the content of the prediction model is confirmed and the adapted algorithm is performed. After that, in Step S10010, an algorithm IP is used for “Iterative prediction” by automation program, and as shown in Step S10012, the prediction result and the accuracy evaluation data are outputted. The algorithm IP will be described later.

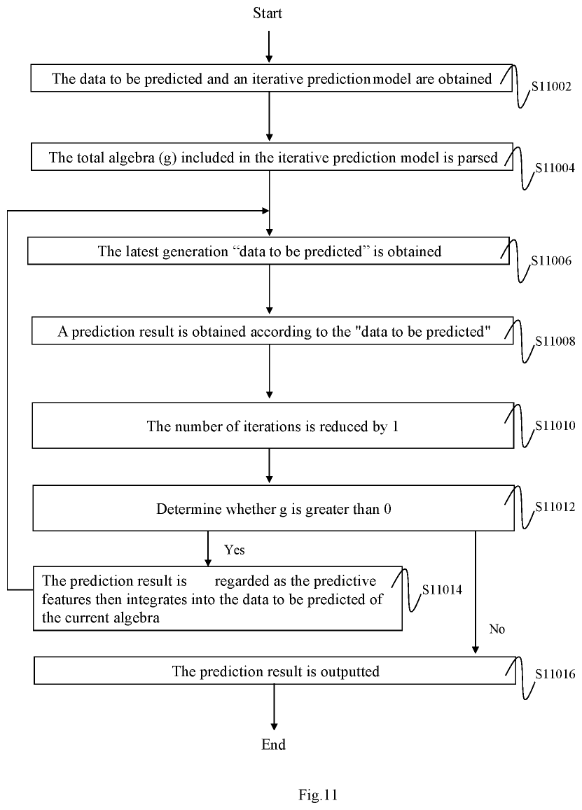

FIG. 11 shows an iterative prediction method (algorithm IP) according to an embodiment of the present invention.

In Step S11002, the data to be predicted and an iterative prediction model are obtained. In Step S11004, the total algebra (g) included in the iterative prediction model is parsed. In Step S11006, the latest generation “data to be predicted” is obtained, then, in Step S11008, a prediction result is obtained according to the “data to be predicted”. It is noted that, in some embodiments, the “data to be predicted” of the current algebra may be put into an algorithm P for prediction so as to obtain a prediction result. Algorithm P will be described later. It is noted that, the model used in the prediction is taken from the iterative prediction model above and must match the current data algebra. After that, as in Step S10010, the number of iterations is reduced by 1 (g=g−1). In Step S11012, it determines whether g is greater than 0 (g>0). When g is greater than 0 (“Yes” in Step S11012), as in Step S11014, the prediction result obtained in Step S11008 is regarded as the predictive features and integrates into the data to be predicted of the current algebra, then becomes a new generation data to be predicted. Thereafter, the flow returns to Step S11006. When g is not greater than 0 (“No” in Step S11012), in other words, when each generation model in the iterative prediction model is completely used in sequence, as in step S11016, the prediction result is outputted.

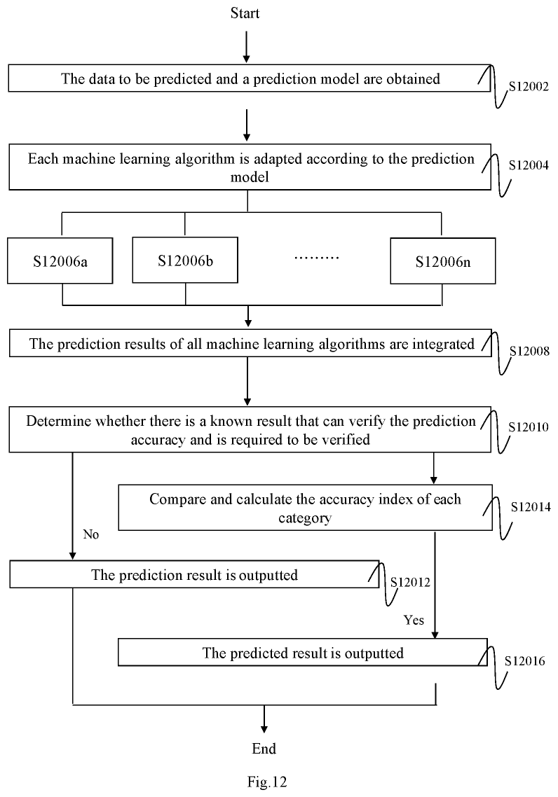

FIG. 12 shows a modularized data prediction method (algorithm P) according to an embodiment of the present invention.

In Step S12002, the data to be predicted and a prediction model are obtained. It is noted that, in some embodiments, the known result of the corresponding data to be predicted may be further received. In Step S12004, each machine learning algorithm is adapted according to the prediction model, and as in Step S12006a, S12006b, . . . , S12006n, the data to be predicted is put into a modularized program and the machine learning methods are initially selected for prediction. In some embodiments, the modularized procedure can be performed by using an algorithm AP. The algorithm AP will be described later. As in Step S12008, the prediction results of all machine learning algorithms are integrated. It is noted that, in some embodiments, the integration method can use all machine learning algorithms to calculate the average of the predicted value of the same data . In Step S12010, it determines whether there is a known result that can verify the prediction accuracy and is required to be verified. When there is no known result to verify the prediction accuracy and there is no request for verification (“No” in Step S12010), as in Step S12012, the prediction result is outputted. When there is a known result to verify the prediction accuracy and there is a request for verification (“Yes” in Step S12010), as in Step S12014, the prediction result is compared with the known result and various types of accuracy index are calculated. As in Step S12016, the predicted results and/or various types of accuracy index are outputted. In some embodiments, the accuracy index includes accuracy, AUC, and MCC.

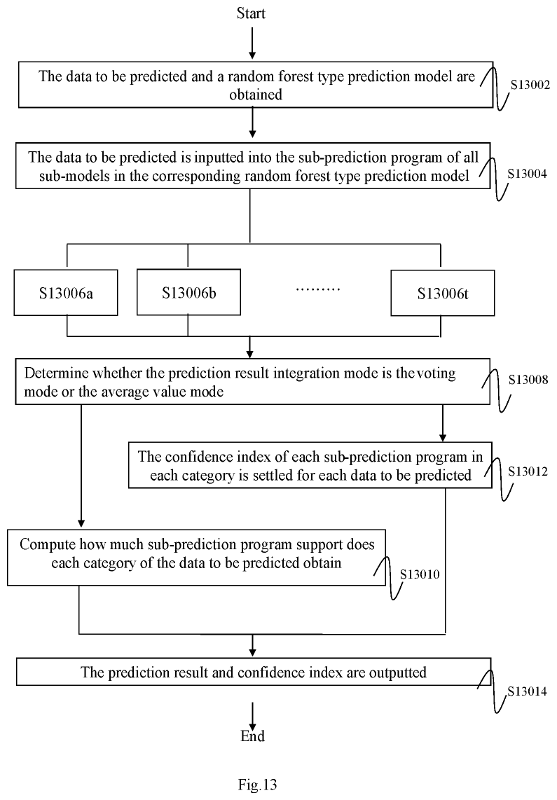

FIG. 13 shows a random forest data prediction method (algorithm AP) according to an embodiment of the present invention. In this embodiment, the random forest data prediction can be performed. By using the algorithm AP and the algorithm AT, the “bias” and the “over-adaptation” level of the prediction system can be effectively reduced.

In Step S13002, the data to be predicted and a random forest type prediction model are obtained, and the machine learning method to be used is set according to the random forest type prediction model. As in Step S13004, the data to be predicted is inputted to the sub-prediction program of all sub-models in the corresponding random forest type prediction model, and as in Step S13006a, S13006b, . . . , S13006t, the individual sub-prediction program in the random forest-based prediction model is used to predict according to the data to be predicted, thereby to obtain the prediction result and the probability value. It is assumed that if there are t sub-models in the prediction model, then there will be t sub-prediction programs. In step S13008, it determines that the prediction result integration mode is the voting mode or the average mode. When the prediction result integration mode is the voting mode, as in Step S13010, how much sub-prediction program support does each category of the data to be predicted obtain is computed. Wherein, the category with the highest number of votes is the prediction result and the proportion of votes in each category is its confidence index. After that, as in Step S13014, the prediction result and confidence index will be outputted. When the prediction result integration mode is the average mode, as in step S13012, the confidence index of each sub-prediction program in each category is settled for each data to be predicted. Wherein, the confidence index of each category is the average probability value of all sub-procedures in this category, and the category with the highest confidence index is the prediction result. After that, as in Step S13014, the prediction result and the confidence index will be outputted.

Therefore, through the system and method for creating the optimal prediction model and obtaining the prediction results based on the machine learning, the automation and modular design can be used for the model training and prediction of machine learning, so as to obtain the machine learning training programs with more efficiency and the prediction results with more accuracy.

The method of the present invention, or a specific type or its part thereof, can exist in the form of a program code. The program code may be included in a physical media, such as a floppy disk, a compact disk, a hard disk, or storage media that can be read by any other machine (such as a computer), or it is not limited to a computer program product of an external form, wherein, when the program code is loaded and executed by a machine, such as a computer, the machine becomes a device which participating in the present invention. The program code can also be transmitted via some transmission media, such as a wire or cable, fiber optic, or any transmission type, wherein, the machine becomes a device which participating in the present invention when the program code is received, loaded and executed by a machine, such as a computer. When implementing in a general purpose processing unit, the program code combining with the processing unit provides a unique device of operation similar to the applied specific logic circuit.

Although the present invention has been described in terms of specific exemplary embodiments and examples, it will be appreciated that the embodiments disclosed herein are for illustrative purposes only and various modifications and alterations might be made by those skilled in the art without departing from the spirit and the scope of the invention as set forth in the following claims.

What the claimed is:

1. A method for creating an optimal prediction model based on machine learning comprises the following steps:
a) A training data set with a data format is provided by a user, and a plural machine learning algorithm to be used, an operation magnitude and a target prediction accuracy are selected;
b) A conversion program is used for obtaining a formatted original data by converting the data format of the training data to a relay format, and the machine learning algorithms is set with the first predictive features and a parameter setting group;
c) The data values of the formatted original data are divided into a sub-training set and a sub-testing set;
d) The first sub-predictive model is created by using the machine learning algorithm and the data values contained in the sub-training set;
e) The data values contained in the sub-testing set are subject to the first sub-prediction model and the first accuracy is obtained by the plural prediction algorithm;
f) If the data values of the formatted original data are used as both the sub-training set and the sub-testing set, or the number of repetitions meets the maximum number of repetitions, the n^{th} predictive features and the parameter setting group are modified according to the n^{th} accuracy to obtain the n+1^{th} predictive features and a parameter setting group, conversely, repeat Step c)˜e);
g) The machine learning algorithm is set by the n^{th} predictive features and the parameter setting group. The first prediction model is created by using the machine learning algorithm and the data values contained in the formatted original data;
h) If the n^{th} accuracy meets the target prediction accuracy or the number of repetitions meets the maximum number of repetitions, the n^{th} prediction model is provided as an optimal prediction model Conversely, the n^{th} predictive features and the parameter setting group are modified according to the accuracy and obtain the n+1^{th} predictive features and parameter setting group for setting the machine learning algorithm, then repeating Step c)˜e); and
i) The optimal prediction model and n^{th} accuracy are shown.

2. The method defined in claim 1, wherein, Step h further includes the following steps:
h1) The n+1^{th} predictive features and the parameter setting group are stored into a data temporary storage area; and
h2) If the number of repetitions meets the maximum number of repetitions, the machine learning algorithm will be set by the greatest accuracy selected from the temporary data storage area.

3. The method defined in claim 1, wherein, Step c further includes the following steps:
c1) After the data values of the formatted original data are divided into a training set and a testing set, the data values of the training set are then divided into the sub-training set and the sub-testing set;
And, Step g further includes the following steps:
g1) The first prediction model is created by the machine learning algorithm and the data values contained in the training set;
g2) The data values contained in the testing set are subject to the first prediction model, and the first test accuracy is obtained by using the prediction algorithm; and
g3) The first test accuracy is replaced with the first accuracy.

4. The method defined in claim 1, wherein, Step a further includes the following steps:
a1) Select one balance base number (n) for the use of sample classification;
And, Step d further includes the following steps:
d1) The data values contained in the sub-training set are divided into plural sampling categories by the machine learning algorithm, wherein, the machine learning algorithm has different sampling categories:
d2) A sample combination is created by sampling from each sampling category with the balance base number.
d3) The first sample prediction model is created by using the data values contained in the sample combination; and
d4) Repeat Step d2)˜d3) until the maximum number of repetitions (t) is met to obtain a plural sample prediction model, then combine the sample prediction models to form the first sub-prediction model.

5. The method defined in claim 1, wherein, Step e further includes the following steps:
eap1) the first plural sample accuracy is respectively obtained by the prediction algorithm; and
eap2) The highest confidence index of the first sample accuracy is selected by a voting mode or an average mode becomes the first prediction result.

6. The method defined in claim 1, wherein, Step e further includes the following steps:
e1) The first accuracy index is obtained by comparing the first accuracy and a known result;
And, Step f further includes the following steps:
f1) The n^{th} predictive features and the parameter setting group are modified according to the n^{th} accuracy and the n^{th} accuracy index.

7. The method defined in claim 6, wherein, the accuracy index includes the accuracy, AUC and MCC.

8. The method defined in claim 1, in Step b, the conversion program plurally repeats to compare the data format then, the conversion program is selected.

9. The method defined in claim 1, wherein, the data format is csv file or text file.

10. A method for obtaining an optimal prediction result based on machine learning comprises the following steps:
a) A dataset to be predicted with a data format is provided by a user, and an optimal prediction model as described in item 1 of the application scope and a plural prediction algorithm to be used are selected;
b) A conversion program is used for converting the data format of the data to be predicted into a relay format and obtain a formatted original data; and
c) The data values contained in the formatted original data are subject to the optimal prediction model, and an optimal prediction result and an optimal accuracy index are obtained through the prediction algorithm.

11. The method defined in claim 10, wherein, Step a further includes the following steps:
a1) Further select a maximum number of repetitions;
And, Step c further includes:
c1) The formatted original data is the first formatted original data, and the data values contained in the first formatted original data are subject to the optimal prediction model, and the first prediction result is obtained by the prediction algorithm;
c2) The n^{th} formatted data to be predicted is combined with the n^{th} prediction result for obtaining the n+1^{th} formatted data to be predicted, and then repeat Step c1), until the number of repetitions meets the maximum number of repetitions, which provides the n+1^{th} prediction result as an optimal prediction result.

12. The method defined in claim 11, wherein, Step cl further includes the following steps:
c1p1) The first accuracy is obtained by using the prediction algorithm, and the first accuracy index is obtained by comparing the first accuracy and a known result;
And, Step c2 further includes the following steps:
c2p1) The n+1^{th} accuracy index is provided as the optimal accuracy index.

13. The method defined in claim 12, wherein, the accuracy index includes the accuracy, AUC and MCC.

14. A system for creating an optimal prediction model based on machine learning comprises:
A storage unit is configured to store the training data set with a data format, and a plural machine learning algorithm; and
A processing unit is coupled to the storage unit for configuration to perform the following methods and steps:
a) Receive a maximum number of repetitions and a target prediction accuracy;
b) A conversion program is used for obtaining a formatted original data by converting the data format of the training data to a relay format, and the machine learning algorithm is set by the first predictive features and a parameter setting group;
c) The data values of the formatted original data are divided into a sub-training set and a sub-testing set;
d) The first sub-predictive model is created by using the machine learning algorithm and the data values contained in the sub-training set;
e) The data values contained in the sub-testing set are subject to the first sub-prediction model, and the first accuracy is obtained by the plural prediction algorithm;
f) If the data values of the formatted original data were used as both the sub-training set and the sub-testing set, or the number of repetitions meets the maximum number of repetitions, the n^{th} predictive features and the parameter setting group are modified according to the n^{th} accuracy to obtain a n+1^{th} predictive features and a parameter setting group, conversely, repeat Step c)·e);
g) The machine learning algorithm is set by the n^{th} predictive features and the parameter setting group The first prediction model is created by using the machine learning algorithm and the data values contained in the formatted original data;
h) If the n^{th} accuracy meets the target prediction accuracy or the number of repetitions meets the maximum number of repetitions, the n^{th} prediction model is provided as an optimal prediction model. Conversely, the n^{th} predictive features and the parameter setting group are modified according to the accuracy to obtain a n+1^{th} predictive features and a parameter setting group for setting the machine learning algorithm, then, repeat Step c)˜e); and
i) The optimal prediction model and the n^{th} accuracy are shown.

15. A method for obtaining an optimal prediction result based on machine learning comprises:
A storage unit is configured to store the dataset to be predicted with a data format, an optimal prediction model and a plural prediction algorithm; and
A processing unit is coupled to the storage unit for configuration to perform the following methods and steps:
a) Select the optimal prediction model and the prediction algorithm;
b) A conversion program is used for obtaining a formatted original data by converting the data format of the training data to a relay format; and
c) The data values contained in the formatted original data are subject to the optimal prediction model, then, an optimal prediction result and an optimal accuracy index are obtained through the prediction algorithm.
